(19) United States
(12) Patent Application Publication
(10) Pub. No.: US 2005/0284698 A1
(43) Pub. Date: Dec. 29, 2005

(54) Ladder support

(76) Inventor: Carter Allen, Whitefish, MT (US)

Correspondence Address: Burkhart & Burkhart;Patent Attorneys, 940 Dakota Avenue, Whitefish, MT, 59937, US

(21) Appl. No.: 10/882,694

(22) Filed: Jun. 29, 2004

(51) Int. Cl. E06C 9/00

(52) U.S. Cl. 182/82

(57) ABSTRACT

A support assembly for securing a ladder to a structure includes an upper ladder support element extending through first and second ends of a first, upper rung of the ladder. A lower ladder support element extends through first and second ends of a second, lower rung of the ladder. A first upper lateral connection is secured to the structure and to the upper ladder support element adjacent to the first end of the first, upper rung of the ladder. A second upper lateral connection is secured to the structure and to the upper ladder support element adjacent to the second end of the first, upper rung of the ladder. A first lower lateral connection is secured to the structure and to the lower ladder support element adjacent to the first end of the first, lower rung of the ladder. A second lower lateral connection is secured to the structure and to the lower ladder support element adjacent to the second end of the first, lower rung of the ladder.

### FIELD OF THE INVENTION

The present invention relates generally to supports, and particularly to supports for ladders used to access construction surfaces from above or below.

### BACKGROUND OF THE INVENTION

Of all implements commonly used at construction sites, the ladder is perhaps the most conspicuously dangerous. Yet, despite the fact that a ladder is one of the simplest and easiest-to-use tools in the construction industry, recent accident statistics suggest that abuse and misuse ladders in the workplace is a rule rather than an exception.

Federal regulations require employers to provide a training program to reach employees using ladders. The training must enable each employee to recognize hazards related to ladders. Most ladder accidents are the result of careless or improper ladder usage, making a well-designed and well-taught ladder safety program well worth the effort.

Top support for a ladder is as important as good footing. The top should rest evenly against a flat, firm surface. If a ladder is to be leaned against roof gutters, the strength and stability of the gutters should first be tested. When a ladder is used for access to an upper landing surface, it must extend three rungs, or at least three feet above the landing surface. A ladder used for access to an upper landing surface should be secured against sideways movement at the top or held by another worker whenever it is being used. The most common way to accomplish this is by “tying off” the ladder to a nearby gutter or overhang. Unfortunately, such features are not always conveniently placed near desired ladder locations. Particularly during construction projects, such features may not even be present. Even under the best of circumstances, tying off the ladder is dependent upon the skill of the workman doing the tying, as well as the integrity of the materials used.

Not surprisingly, various ladder support arrangements have found their way into the patent literature. For example, U.S. Pat. No. 5,165,501 to Donahey is directed to a ladder support attachment for hollow rung ladders. The attachment is designed to pivot and lock a pair of arms (with a support plate across one end) so as to offset and support a ladder top from a roof of any slope (pitch) or to pivot the support plate upward and support the ladder top a selectable distance from a vertical wall or to further pivot upward and place the support plate between the ladders rail tops and any fragile siding to protect the siding from damage. A pair of adjustable length pivotal upper arms connected to a pair of adjustable length pivotal lower arms. The upper arms control the distance from ladder to support plate while the lower arms control the angle of the upper arms (and support plate). The pivotal action allows a simple change from one support position to another. A second configuration uses an optional support plate to support the ladder top from the peak of a roof. In a third configuration, the ladder attachment is attached to the bottom of a ladder to significantly improve base stability.

In another example, U.S. Pat. No. 6,527,084 to Hrincu deals with a ladder stabilizer including a substantially planar rigid frame having two legs depending in spaced apart relation with a fixed angular relationship to the frame. The frame has a first end and a second end, with remote ends of the two legs defining the second end. A pivot bar is provided which is secured to a selected rung of a ladder. Pivot bar retention brackets are secured to the frame in spaced relation adjacent to the first end. The ladder stabilizer described can be attached to a ladder without drilling bolt apertures.

U.S. Pat. No. 6,019,191 to Flores shows a ladder support system for use in securely mooring the top of a ladder to a roof while simultaneously eliminating any destructive contact between the ladder and the roof materials. The ladder support system includes a pair of frame portions which are secured to the roof and which are structured to support opposite ends of a bar. To prevent the ladder from rotating away from the roof when being used, a strap is provided for securing the ladder to the bar. Each frame portion is provided with a blocking means to prevent lateral movement of the ladder when the ladder is supported by the bar. A means is also provided to prevent accidental loss of bar support at each frame portion.

U.S. Pat. No. 6,382,353 to Laug is directed to a slip prevention device for ladders. In the lower area of a ladder two pull or pressure rods are arranged on either side in a pivoting manner. Via sliding sleeves and joints said rods are joined to telescopic support elements which are each arranged at the level of an upright of the ladder. For greater stability the telescopic support elements are connected to each other via an auxiliary bar whose length can also be adjusted.

U.S. Pat. No. 5,743,356 to Mitchell shows a ladder extender apparatus for use with a ladder with stiles and rungs to extend the ladder away from a structure, during use and adapted to accept any width ladder, hollow runged or solid runged, comprising a flat base plate to engage with the roof of the structure, two support arms rigidly affixed to the base plate by two L-shaped channels and extending vertically away from the base plate adjustable horizontally with the base plate, a corresponding pair of extension arms pivotally secured at one end with a rod to the pair of support arms allowing the base plate to pivot about the axis of the rod and adjust to the pitch of the roof of the structure and adjustable by a plurality of orifices in the support arms to vary the distance of the ladder from the structure and with the other ends of the extension arms secured to a ladder fastener assembly to fasten the apparatus to the stiles and rungs of the ladder, where the ladder fastening assembly can be either a pair of generally U-shaped channels with slots adapted to accept and engage two rungs of the ladder with a security fastening means to prevent the channels from disengaging from the ladder or a pair of blocks with orifices to provide for the sliding of a rod through the blocks and a hollow rung of a ladder with slots in the blocks adapted to slidably engage with the stiles of the ladder.

U.S. Pat. No. 4,565,262 to Hawkins deals with a ladder apparatus having an elongated ladder assembly, a pair of pivotally mounted supporting legs, braces positionable to interconnect the legs and the ladder assembly to retain the legs in stable supporting relation to the ladder assembly, a collapsible platform borne by the ladder assembly and an adjustable leveling device mounted on the ladder assembly for ground engagement to support the ladder assembly on uneven surfaces. An auxiliary support assembly adapted for attachment to a ladder assembly having the foregoing elements.

It can thus be seen from the foregoing that several attempts have been made to devise improved apparatus for securing ladders to various surfaces. However, it equally can be seen that the need exists for a simple, efficient, and inexpensive method and apparatus of securing a ladder to an elevated work surface.

### SUMMARY OF THE INVENTION

A support assembly for securing a ladder to a structure includes an upper ladder support element extending through first and second ends of a first, upper rung of the ladder. A lower ladder support element extends through first and second ends of a second, lower rung of the ladder. A first upper lateral connection is secured to the structure and to the upper ladder support element adjacent to the first end of the first, upper rung of the ladder. A second upper lateral connection is secured to the structure and to the upper ladder support element adjacent to the second end of the first, upper rung of the ladder. A first lower lateral connection is secured to the structure and to the lower ladder support element adjacent to the first end of the first, lower rung of the ladder. A second lower lateral connection is secured to the structure and to the lower ladder support element adjacent to the second end of the first, lower rung of the ladder.

### DESCRIPTION OF THE DRAWINGS

FIG. 1 illustrates a schematic front elevational view of a support assembly in accordance with the principles of the present invention.

FIG. 2 is a side elevational view of the FIG. 1 support assembly.

FIG. 3 is a detailed side sectional view of a connection in the FIG. 1 support assembly.

FIG. 4 is a schematic detailed side sectional view of the FIG. 1 support assembly.

FIG. 5 is a side elevational view of another support assembly in accordance with the principles of the present invention.

FIG. 6 is a detailed side sectional view of a connection in the FIG. 5 support assembly.

FIG. 7 is a schematic detailed rear view of the FIG. 5 support assembly.

FIG. 8 is a schematic detailed side view of the FIG. 5 support assembly.

FIG. 9 is a side elevational view of another support assembly in accordance with the principles of the present invention.

FIG. 10 is a detailed side sectional view of a portion of the FIG. 9 support assembly.

FIG. 11 is a side elevational view of another support assembly in accordance with the principles of the present invention.

FIG. 12 is a detailed side sectional view of a connection in the FIG. 11 support assembly.

FIG. 13 a schematic front elevational view of the FIG. 11 support assembly.

### DETAILED DESCRIPTION OF THE INVENTION

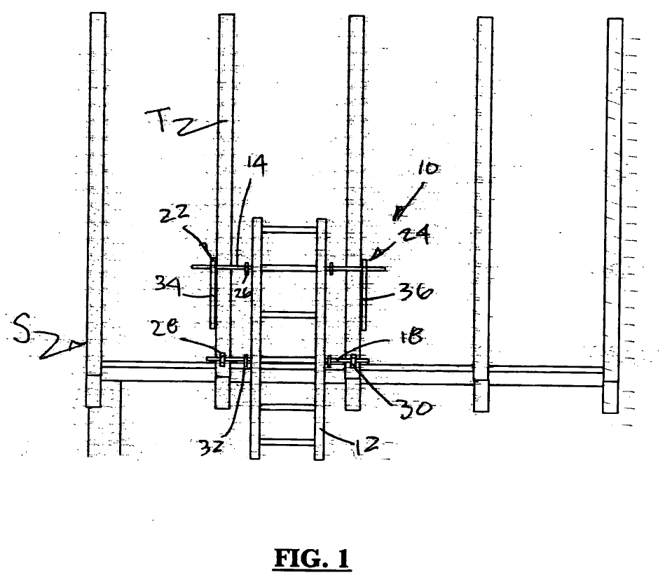

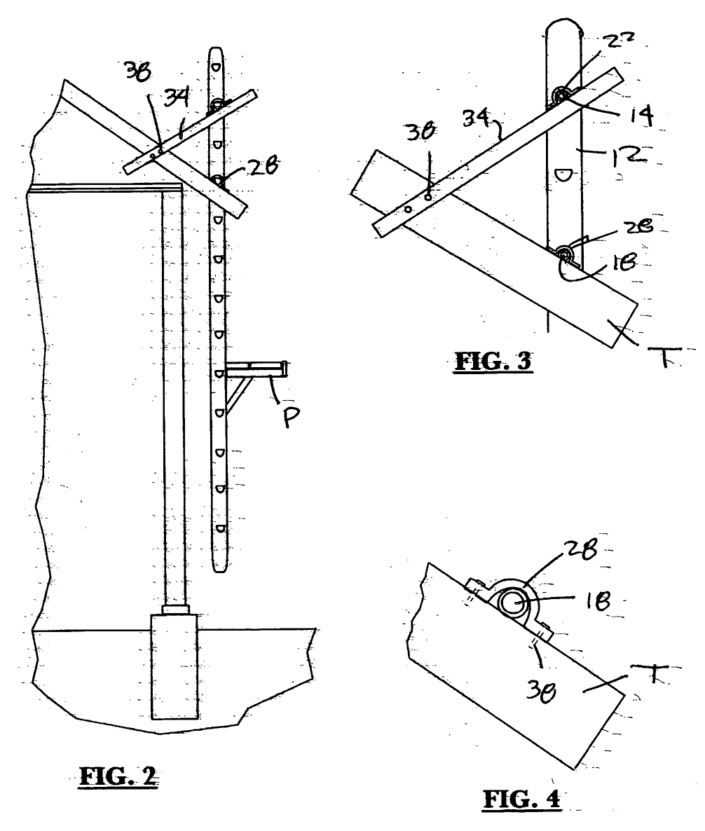

FIGS. 1 and 2 illustrate a support assembly 10 for securing a ladder 12 to a structure S. In the embodiment shown in FIGS. 1-4, the structure S includes a plurality of truss members T. It is typical during construction of a building to require worker access to upper levels of the structure S when the truss members are in place.

The support assembly 10 includes an upper ladder support element 14 extending through first and second ends of a first, upper rung 16 of the ladder 12. A lower ladder support element 18 extends through first and second ends of a second, lower rung 20 of the ladder 12. The upper and lower ladder support elements 14, 18 can be provided as lengths of pipe. The size of the pipe can be chosen to accommodate the particular dimensions of the ladder and structure. It has been found that ⅞″ OD pipe, preferably metal pipe such as steel pipe, in lengths of between 3 and 6 feet, provide particular advantage.

A first upper lateral connection 22 is secured to the structure S and to the upper ladder support element 14 adjacent to the first end of the first, upper rung 16 of the ladder 12. A second upper lateral connection 24 is secured to the structure S and to the upper ladder support element 14 adjacent to the second end of the first, upper rung 16 of the ladder 12. The upper ladder support element 14 can be provided with selectively usable fasteners 26, such as cotter pins, to assist in keeping the upper ladder support element 14 within the upper rung 16.

A first lower lateral connection 28 is secured to the structure S and to the lower ladder support element 18 adjacent to the first end of the first, lower rung 20 of the ladder 12. A second lower lateral connection 30 is secured to the structure S and to the lower ladder support element 18 adjacent to the second end of the first, lower rung 20 of the ladder 12. The lower ladder support element 18 can be provided with selectively usable fasteners 32, such as cotter pins, to assist in keeping the upper ladder support element 18 within the upper rung 20.

As seen in FIGS. 3 and 4, the first and second lower lateral connections 28, 30 can be connected directly to the structure S. In the illustrated embodiment, the first and second lower lateral connections 28, 30 are provided as pipe straps connected directly to the truss members T of the structure S.

The first and second upper lateral connections 22, 24 include connection members 34, 36 extending between the upper lateral connections 22, 24 and the structure S. In the illustrated embodiment, the connection members are secured to the upper lateral connections and to the truss members T at respective ends thereof. Suitable, readily available fasteners, such as screws 38, can be used to make the various connections in a known manner.

As can be seen in FIG. 2, the support assembly 10 uses the structure S to provide ample support for the ladder 12, eliminating the need for solid “footing” for the ladder 12. It may be desirable to mount other elements, such as a scaffold platform P, as desired.

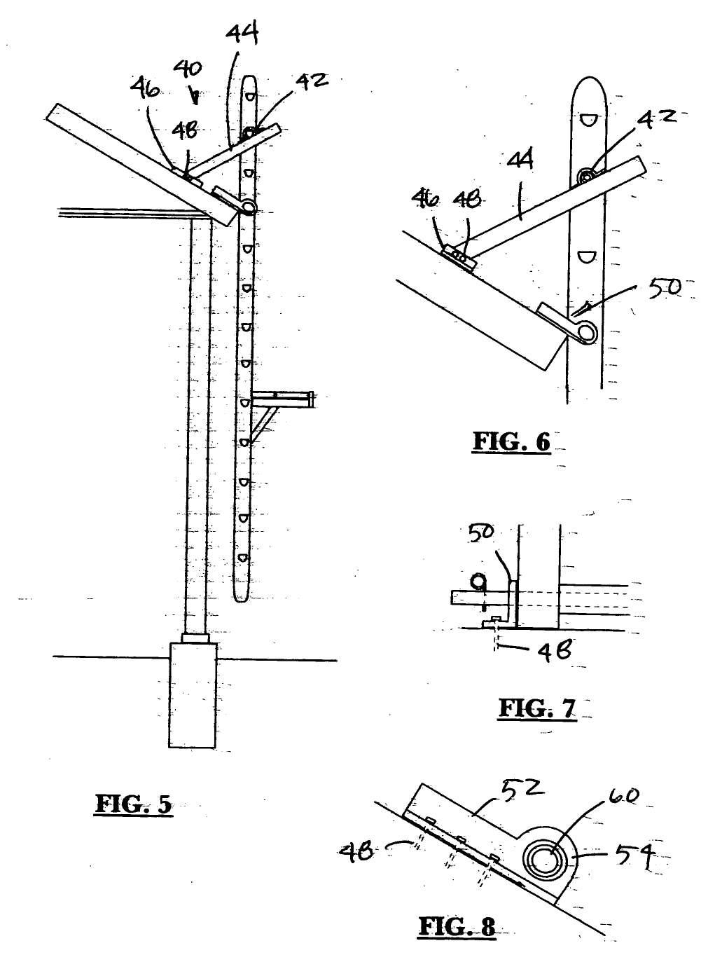

An alternative embodiment of a support assembly 40 in accordance with the principles of the present invention is shown in FIGS. 5-8. The support assembly 40 is similar to the embodiment shown in FIGS. 1-4 in its use of upper and lower ladder support elements extending through upper and lower rungs of a ladder. However, the support assembly 40 is adapted for use with a structure S′ having a planar, inclined surface I, such a roof decked with plywood or similar material. The truss members T are therefore covered and inaccessible for support purposes.

In the embodiment shown in FIGS. 5-8, upper lateral connections 42 are connected to the inclined surface I via elongate connection members 44 and pads 46. The upper lateral connections 42 can be provided as pipe straps, and connection members 44 can be provided as standard dimensional lumber, as with the previous embodiments. The connection members 44 are secured to the inclined surface via pads 46, which can be provided as angled metal connectors. Fasteners 48 such as screws or nails can be used to secure components together in a known manner.

Lower lateral connections 50 include a connection portion 52 adapted and constructed for direct attachment to the inclined surface I of the structure S′. A strap portion 54 is adapted and constricted for direct attachment to the lower ladder support element, that is, the lower lateral support element fits through the strap portion 54, as best seen in FIGS. 7 and 8. As with the previous embodiment, selectively usable fasteners 56, such as cotter pins, assist in keeping the upper ladder support element 18 within the upper rung 20.

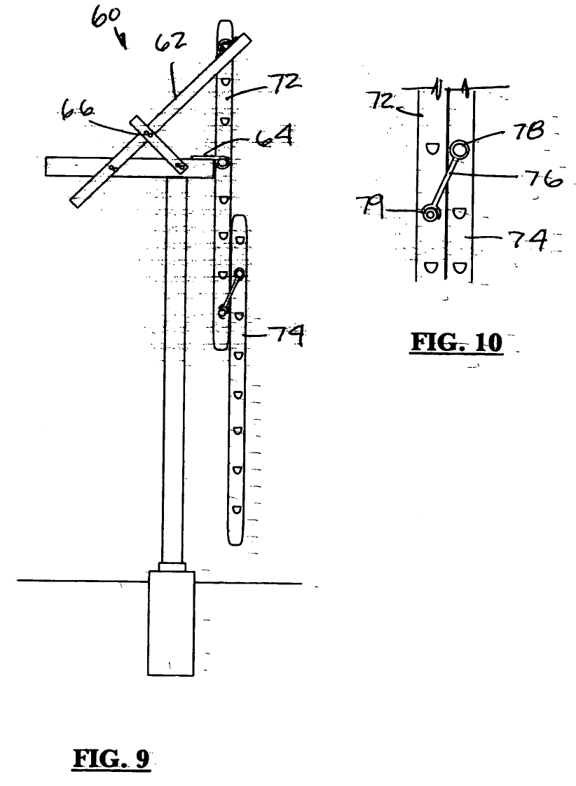

Another alternative embodiment of a support assembly 60 in accordance with the principles of the present invention is shown in FIGS. 9 and 10. The support assembly 60 is similar to the embodiment shown in the previously-described embodiments in its use of upper ladder support elements 62 and lower ladder support elements 64 extending through upper and lower rungs of a ladder. The upper support elements 62 include support members 66 and 68 connected together for increased stability. The lower support element 62 is similar in structure to that shown in FIGS. 7 and 8. The ladder 70 is illustrated as an extension ladder having an upper section 72 and a lower section 74. In use, a typical extension ladder includes a catch arrangement to prevent the upper ladder section from sliding downwardly. However, in arrangements such as that shown in the support assembly 60, it is the lower ladder section 74 that should optimally be prevented from sliding. To this end, a catch mechanism 76 is provided. The catch mechanism 76 is pivotally secured to a rung of the lower ladder section 74 via a first connection element 78, while a second connection element 79 rests securely on a rung of the upper ladder section 72. In this manner, the lower section 72 is prevented from sliding down when the bottom of the ladder 70 is above the support surface S.

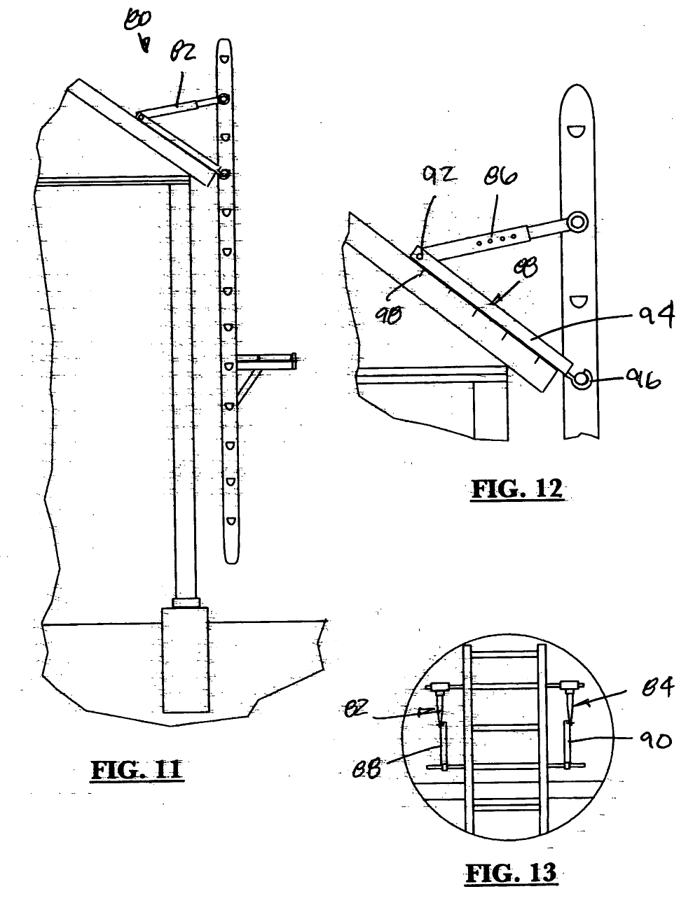

An alternative embodiment of a support assembly 80 in accordance with the principles of the present invention is shown in FIGS. 11-13. The support assembly 80 includes telescoping upper lateral connections 82, 84 (FIG. 13). The telescoping members 82, 84 are incrementally secured together in a conventional manner by adjustment members 86, such as by spring detents and corresponding holes, to be adjustable in length. It is contemplated that a spacing of about ⅝″ between such adjustment members 86 will provide sufficient adjustability to accommodate a wide variety of pitches, as well as allowing for a relatively easy, fast, and safe assembly process, while reducing the number of parts required.

The support assembly 80 also includes lower lateral connections 88, 90 connected to the upper lateral connections 82, 84 via hinged connections 92. The lower lateral connections 88, 90 are provided with an attachment section 94 and a hook member 96. The attachment section 94 is adapted and constructed to be secured to the structure with fasteners 98 such as screws or nails, used to secure components together in a known manner. A nail or other fastener can be passed through the hook member 96 and the lower pipe to provide additional security. The hook member 96 is adapted and constructed to receive the lower length of pipe extending through the ladder rung, as described with respect to previous embodiments. In a similar manner, the upper lateral connections 82, 84 are provided with T-fittings 100, 102 to receive the upper length of pipe extending through the second ladder rung.

Although the present invention has been described with reference to specific embodiments, those of skill in the art will recognize that changes may be made thereto without departing from the scope and spirit of the invention as defined by the appended claims.

1. A support assembly for securing a ladder to a structure, the support assembly comprising the following:
an upper ladder support element extending through first and second ends of a first, upper rung of the ladder;
a lower ladder support element extending through first and second ends of a second, lower rung of the ladder;
a first upper lateral connection secured to the structure and to the upper ladder support element adjacent to the first end of the first, upper rung of the ladder;
a second upper lateral connection secured to the structure and to the upper ladder support element adjacent to the second end of the first, upper rung of the ladder;
a first lower lateral connection secured to the structure and to the lower ladder support element adjacent to the first end of the first, lower rung of the ladder;
a second lower lateral connection secured to the structure and to the lower ladder support element adjacent to the second end of the first, lower rung of the ladder.

2. A support assembly in accordance with claim 1, wherein the first and second lower lateral connections are connected directly to the structure.

3. A support assembly in accordance with claim 2, further comprising respective connection members extending between the upper lateral connections and the structure.

4. A support assembly in accordance with claim 1, wherein the support elements comprise pipes.

5. A support assembly in accordance with claim 4, wherein the support elements comprise metal pipes.

6. A support assembly in accordance with claim 5, wherein the support elements comprise steel pipes having a diameter of approximately ⅞″.

7. A support assembly in accordance with claim 1, wherein the lateral connections comprise pipe straps.

8. A support assembly in accordance with claim 3, wherein the structure includes a plurality of truss elements, and the connection members are secured to respective side surfaces of the truss elements.

9. A support assembly in accordance with claim 3, wherein the structure includes an inclined, planar surface, and the connection members comprise the following:
at least one attachment pad secured to the inclined surface; and
at least one elongate connection element secured between an upper lateral connection and the pad.

10. A support assembly in accordance with claim 1, wherein the lower lateral connections comprise the following:
a connection portion adapted and constricted for direct attachment to the structure; and
a strap portion adapted and constricted for direct attachment to the lower ladder support element.
